(19) United States
(12) Patent Application Publication
(10) Pub. No.: US 2013/0271379 A1
(43) Pub. Date: Oct. 17, 2013

(54) CHARACTER INPUT DEVICE AND CHARACTER INPUT METHOD

(71) Applicant: Hisashi Ide, Osaka-shi (JP)

(72) Inventor: Hisashi Ide, Osaka-shi (JP)

(73) Assignee: SHARP KABUSHIKI KAISHA, Osaka-shi, Osaka (JP)

(21) Appl. No.: 13/976,107

(22) PCT Filed: Jan. 19, 2012
(86) PCT No.: PCT/JP2012/051036

§ 371 Date: Jun. 26, 2013

(30) Foreign Application Priority Data
Jan. 27, 2011 (JP) 2011-014718

(51) Int. Cl. G06F 3/041

(52) U.S. Cl. CPC G06F 3/041
USPC 345/168

(57) ABSTRACT

The objective of the present invention is to allow a user to efficiently perform character input even if an area for placement of keys is narrow and individual key sizes are small. A display portion (11) displays a virtual keyboard including a plurality of character input keys; a touch panel (12) detects a position touched by a finger; a movement direction detection portion (14a) detects a movement direction in which a finger has moved without moving away from the touch panel (12) after the touch panel (12) has been touched; a storage portion (13), in association with information of the movement direction of the finger, stores adjacent character information (13a) for registering information of characters of adjacent character input keys which are placed adjacent to the touched character input key; and an input character setting portion (14b), on the basis of the position and movement direction in which the touch panel has been touched as well as the adjacent character information (13a), sets, as an input character, one character which has been extracted from among the character corresponding to the character input key that has been touched by the finger and the characters corresponding to the adjacent character input keys placed adjacent to the character input key.

### TECHNICAL FIELD

The present invention relates to a character input device and a character input method to execute input processing of a character.

### BACKGROUND ART

A number of terminal devices such as portable phones, electronic dictionaries, portable PCs (Personal Computers) and tablet terminals have been sold in recent years. For such terminal devices, miniaturization of a housing has been required at all times. Thus, the situation does not allow extension of an area available for placement of keys for inputting characters.

For example, Patent Document 1 discloses a technology in which a virtual keyboard having keys placed like a honeycomb is displayed on a screen, and a user slides his/her finger on a touch pad, whereby a key in a selected state on the virtual keyboard is moved for making it possible to easily input various kinds of characters by using a limited space. In the technology, the key which was in the selected state when the user moved the finger away from the touch pad is determined as an entered key.

In the technology of Patent Document 1, the key in the selected state on the virtual keyboard is allowed to be corrected until when the user moves the finger away from the touch pad, thus the user, even when touching a wrong key, is allowed to slide the finger as it is and select a target key.

### PRIOR ART DOCUMENT

### Patent Documents

Patent Document 1: Japanese Laid-Open Patent Publication No. 2003-196007

### SUMMARY OF THE INVENTION

### Problem to be Solved by the Invention

However, sizes of individual keys on a virtual keyboard are small on a terminal device having a small area for displaying the virtual keyboard, thus even when trying to select a target key by sliding a finger, movement of the finger is forced to be small and required to be subtle. Therefore, there has been a problem that the finger passes the target key to unwillingly select the next key, and thus it is not possible to select the target key successfully, thereby making it difficult to quickly correct the key in the selected state.

In view of the above-described problem, the present invention aims to provide a character input device and a character input method to allow a user to efficiently perform character input even when an area for placement of keys is small and individual key sizes are small.

### Means for Solving the Problem

To solve the above problems, a first technical means of the present invention is a character input device for executing character input processing, comprising a display portion for displaying a virtual keyboard including a plurality of character input keys corresponding to respective characters; a touch panel for detecting a position touched by a finger on the virtual keyboard displayed by the display portion; a movement direction detection portion for detecting a movement direction in which the finger moves without moving away from the touch panel after the touch panel is touched; a storage portion for storing adjacent character information in which information on characters of adjacent character input keys that are adjacent to the touched character input keys is registered, in association with information on the movement direction of the finger in which the finger moves without moving away from the touch panel after the character input key is touched; and an input character setting portion for extracting one character from among the character corresponding to the character input key that is touched by the finger and characters corresponding to the adjacent character input keys placed adjacent to the touched character input key based on the position of the touch panel touched by the finger, the movement direction detected by the movement direction detection portion, and the adjacent character information stored in the storage portion to set the extracted character as an input character.

A second technical means of the present invention is the character input device of the first technical means, wherein the adjacent character information stored in the storage portion is set based on key arrangement of the virtual keyboard which is displayed before the touch is performed on the touch panel by the finger.

A third technical means of the present invention is the character input device of the first or second technical means, wherein the movement direction detection portion detects a first movement distance of a finger on a first coordinate axis and a second movement distance of the finger on a second coordinate axis perpendicular to the first coordinate axis on an orthogonal coordinate system, the storage portion stores predetermined conditions to be satisfied by the first movement distance and the second movement distance so that the character input key touched by the finger is selected from among the character input key that is touched by the finger or the adjacent character input keys placed adjacent to the touched character input key, and the input character setting portion sets a character corresponding to the character input key that is touched by the finger as the input character in a case where the first movement distance and the second movement distance satisfy the predetermined conditions.

A fourth technical means of the present invention is the character input device of the third technical means, wherein the movement direction detection portion detects the movement direction of the finger based on the first movement distance and the second movement distance.

A fifth technical means of the present invention is the character input device of any one of the first to the third technical means, wherein the movement direction detection portion detects a direction corresponding to an area including the largest part of a trajectory of the finger which has moved without moving away from the touch panel as the movement direction.

A sixth technical means of the present invention is the character input device of any one of the first to the fifth technical means, wherein the display portion displays the virtual keyboard and, when one of the plurality of character input keys is touched, displays key layout information including the touched character input key and adjacent character input keys placed adjacent to the touched character input key in an area different from a display area of the virtual keyboard.

A seventh technical means of the present invention is the character input device of the sixth technical means, wherein the input character decision portion selects, when a finger moves without moving away from the touch panel, one character from among the character corresponding to the character input key that is touched by the finger and the characters corresponding to the adjacent character input keys placed adjacent to the touched character input key based on the position of the touch panel touched by the finger, the movement direction detected by the movement direction detection portion and the adjacent character information stored in the storage portion, and the display portion displays the key layout information in which the character selected by the input character decision portion is highlighted.

An eighth technical means of the present invention is the character input device of any one of the first to the seventh technical means, wherein the display portion performs pop-up display of the character which is set as the input character by the input character decision portion when a finger moves away from the touch panel.

A ninth technical means of the present invention is the character input device of any one of the first to the eighth technical means, wherein the virtual keyboard includes at least character input keys corresponding to 26 alphabets, numbers and symbols that are different from one another.

A tenth technical means of the present invention is the character input device of any one of the first to the ninth technical means, wherein the movement direction detection portion changes a determination condition of a movement direction based on a movement history of a finger that has moved in past times and detect the movement direction based on the changed determination condition when the finger moves without moving away from the touch panel.

An eleventh technical means of the present invention is a character input method of executing character input processing, comprising: a displaying step of displaying a virtual keyboard including a plurality of character input keys corresponding to respective characters; a position detecting step of detecting a position of a touch panel touched by a finger; a movement direction detecting step of detecting a movement direction in which the finger moves without moving away from the touch panel after the touch panel is touched; a reading step of reading, from the storage portion, adjacent character information in which information on characters of adjacent character input keys that are placed adjacent to the touched character input key is registered, in association with information on the movement direction of the finger in which the finger moves without moving away from the touch panel after the character input key is touched; and an input character setting step of extracting one character from among the character corresponding to the character input key that is touched by the finger and the characters corresponding to the adjacent character input keys placed adjacent to the touched character input key based on the position of the touch panel touched by the finger detected at the position detection step, the movement direction detected at the movement direction detection step, and the adjacent character information read out at the reading step to set the extracted character as an input character.

### Effect of the Invention

According to the present invention, a virtual keyboard including a plurality of character input keys corresponding to respective characters is displayed, a position of a touch panel touched by a finger is detected, a movement direction is detected in which a finger moves without moving away from the touch panel after the touch panel is touched, read from a storage portion is adjacent character information in which information on characters of adjacent character input keys placed, in association with information on the movement direction of the finger in a case where the finger moves without moving away from the touch panel after a character input key is touched, adjacent to the touched character input key is registered, and one character is extracted from among the character corresponding to the character input key that is touched by the finger and a character corresponding to any of the adjacent character input keys placed adjacent to the touched character input key based on the position of the touch panel touched by the finger, the movement direction as well as the read adjacent character information to set the extracted character as an input character, so that a user is able to efficiently perform character input even when an area for placement of keys is small and individual key sizes are small. Conversely, individual key sizes are allowed to be smaller, thus making it possible to extend an area other than an area where the virtual keyboard is displayed on the touch panel and display other information on such an area. Moreover, even when a user is not able to touch a desired character input key, it is possible to quickly correct an input character by moving his/her finger in a predetermined direction.

### BRIEF DESCRIPTION OF DRAWINGS

FIG. 1 is a diagram showing an example of a configuration of a character input device according to an embodiment of the present invention.

FIG. 2 is a diagram showing character input screens compared between a conventional character input device and the character input device according to the present embodiment.

FIG. 3 is a diagram showing an example of adjacent character information.

FIG. 4 is a diagram showing an example of a virtual keyboard displayed on a display portion.

FIG. 5 is a diagram explaining about finger movement distance condition information.

FIG. 6 is a diagram explaining about detection processing of a movement direction based on an area including a trajectory of a finger.

FIG. 7 is a diagram explaining about setting change processing of the movement direction.

FIG. 8 is a diagram showing an example of key layout information.

FIG. 9 is a diagram showing an example of highlighting processing of a character input key.

FIG. 10 is a diagram showing an example of pop-up display processing of a character.

FIG. 11 is a flowchart showing an example of a processing procedure of a character input method according to the present embodiment.

### PREFERRED EMBODIMENT OF THE INVENTION

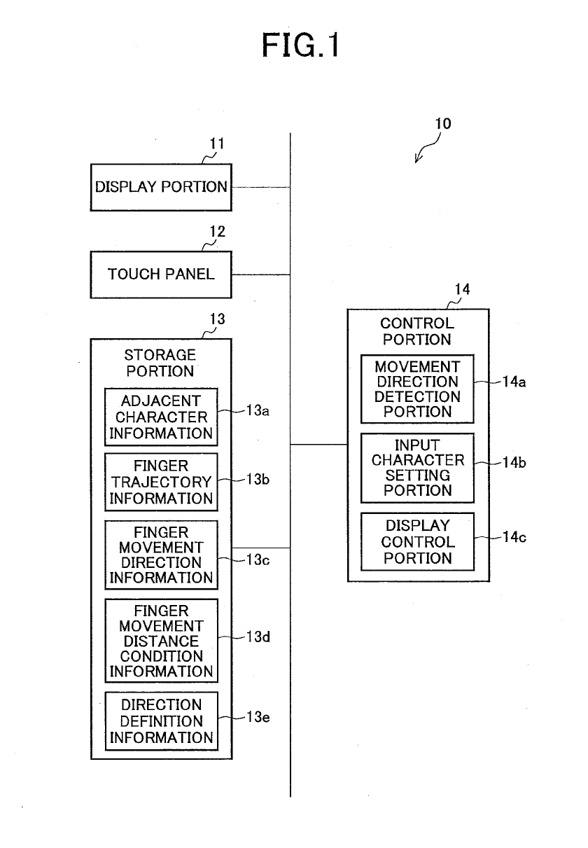

Hereinafter, description will be given in detail for embodiments of the present invention with reference to the drawings. FIG. 1 is a diagram showing an example of a configuration of a character input device 10 according to an embodiment of the present invention. As shown in FIG. 1, the character input device 10 is provided with a display portion 11, a touch panel 12, a storage portion 13 and a control portion 14.

The display portion 11 is a display device such as a liquid crystal display for displaying information on a character, a figure and the like. The touch panel 12 is a touch panel which is provided on the surface of the display portion 11 and detects a position touched by a user.

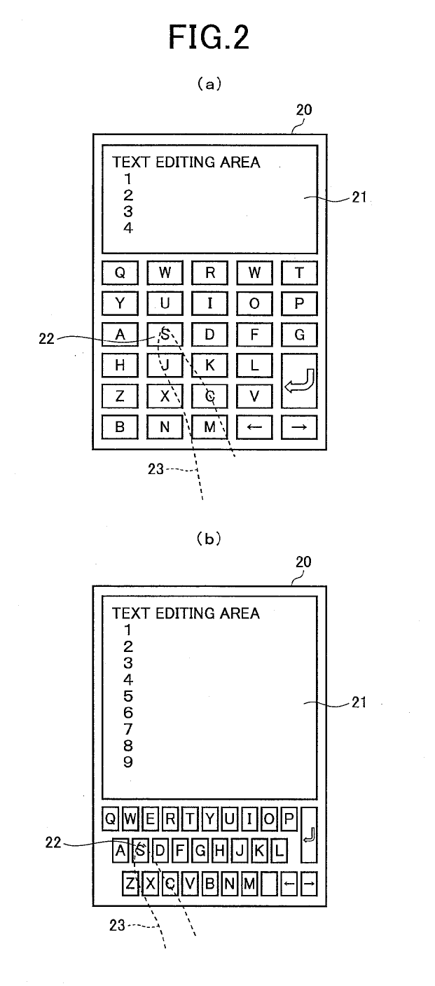

FIG. 2 is a diagram showing character input screens 20 compared between a conventional character input device and the character input device 10 according to the present embodiment. Here, FIG. 2(a) shows the character input screen 20 of the conventional character input device, and FIG. 2(b) shows the character input screen 20 according to the present embodiment. On the conventional character input screen 20 shown in FIG. 2(a), when a user touches the top of the character input key 22 by a finger 23, a character in a position touched by the finger 23 is set as an input character. However, in order to allow a user to touch a target character input key 22 without making a mistake, the character input screen 20 in FIG. 2(a) needs to have the character input key 22 in a large size.

On the other hand, as described below, in the present embodiment, since it is possible to set an input character from information on a position touched by a user and information on the movement direction in which the finger 23 moves without moving away from the touch panel 12, the size of the character input key 22 is allowed to be smaller as shown in FIG. 2(b). This makes it possible to enlarge a text display area 21 for displaying a text created by character input compared to a conventional one.

Returning to the description of FIG. 1, the storage portion 13 is a storage device such as a memory and a hard disk device. The storage portion 13 stores adjacent character information 13a, finger trajectory information 13b, finger movement direction information 13c, finger movement distance condition information 13d and direction definition information 13e.

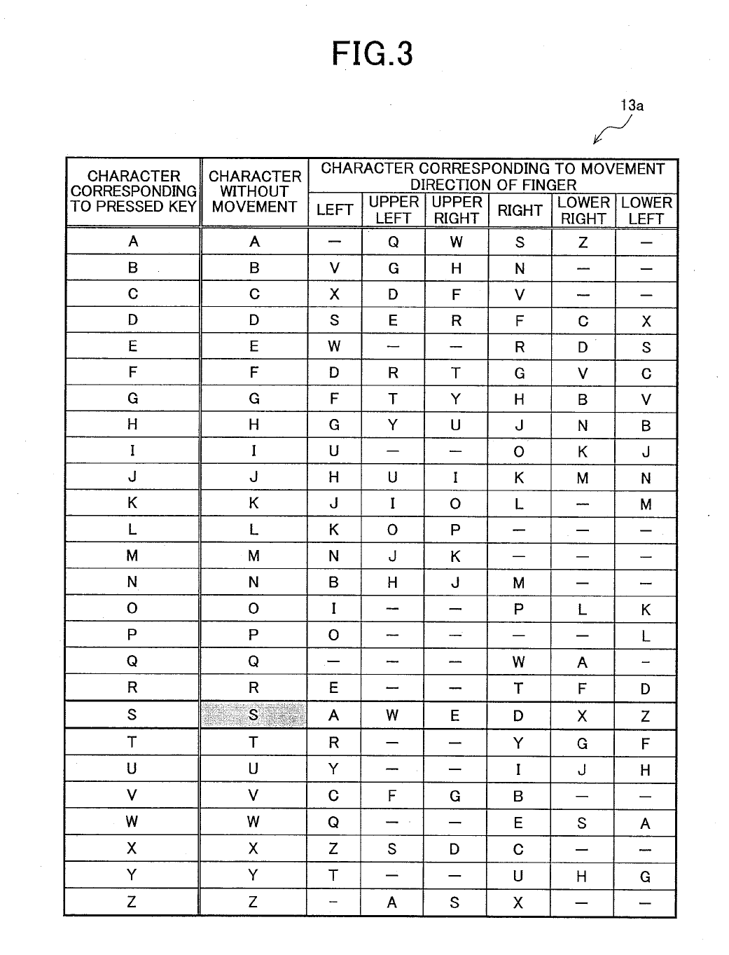

The adjacent character information 13a is information on characters of the character input keys 22 placed, in association with the movement direction of the finger 23 in a case where the finger 23 moves without moving away from the touch panel 12 after the character input key 22 is touched, adjacent to the touched character input key 22 that is registered. Characters registered in association with the movement direction of the finger 23 in the adjacent character information 13a are set in advance based on arrangement of the character input keys 22 displayed on the display portion 11. FIG. 3 is a diagram showing an example of the adjacent character information 13a.

As shown in FIG. 3, information on a “character corresponding to the pressed key”, a “character without movement” and a “character corresponding to the movement direction of the finger” is registered in the adjacent character information 13a. The “character corresponding to the pressed key” is information on a character allocated to the character input key 22 that is touched by a user. The “character without movement” is information on a character which is set as an input character in the case of determining that the finger 23 does not move after the character input key 22 is touched by a user. The “character corresponding to the movement direction of the finger” is information on a character which is set as an input character according to the movement direction of the finger 23 in a case where the finger 23 moves without moving away from the touch panel 12 after the character input key 22 is touched by a user. In the case of arrangement of the character input keys 22 shown in FIG. 2(b), a character is registered in the “character corresponding to the movement direction of the finger” in association with each movement direction to left, upper left, upper right, right, lower right or lower left.

Specifically, in FIG. 3, in a case where the “character corresponding to the pressed key” is “S”, “S” is registered in the “character without movement”, while “A” in association with the movement direction to left, “W” in association with the movement direction to upper left, “E” in association with the movement direction to upper right, “D” in association with the movement direction to right, “X” in association with the movement direction to lower right, and “Z” in association with the movement direction to lower left are registered in the “character corresponding to the movement direction of the finger”. Note that, as arrangement of the character input keys 22, not only the arrangement shown in FIG. 2(b) but also the other arrangement may be employed.

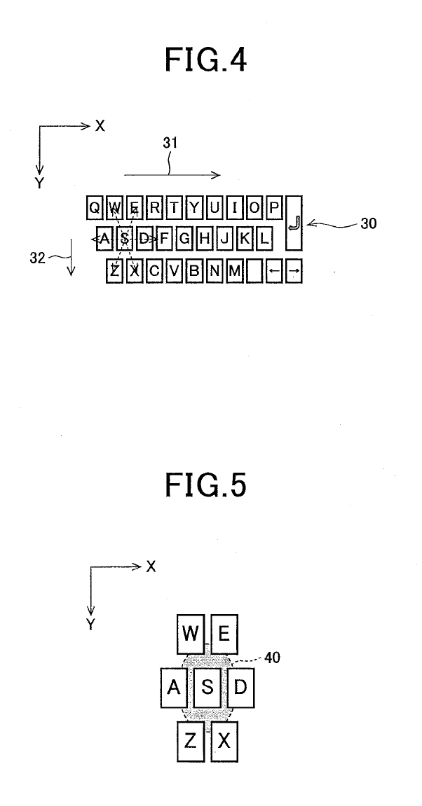

FIG. 4 is a diagram showing an example of a virtual keyboard 30 displayed on the display portion 11. The virtual keyboard 30 shown in FIG. 4 is a QWERTY keyboard including at least character input keys 22 corresponding to 26 alphabets, numbers and symbols that are different from one another. Here, the adjacent character information 13a shown in FIG. 3 is set based on key arrangement of the virtual keyboard 30 displayed before the touch panel 12 is touched by a finger. Therefore, on the virtual keyboard 30, each character input key 22 is displayed so as to conform to the adjacent character information 13a shown in FIG. 3. For example, on the virtual keyboard 30, with respect to a character “S”, a character “A” on the left, a character “W” on the upper left, a character “E” on the upper right, a character “D” on the right, a character “X” on the lower right, and a character “Z” on the lower left are displayed.

Further, for display of the virtual keyboard 30, an X-Y orthogonal coordinate system is set. Additionally, as described below, the movement direction of the finger 23 is detected from a movement distance 31 of the finger 23 in an X-axis direction and a movement distance 32 of the finger 23 in a Y-axis direction.

In this manner, the display portion 11 displays the virtual keyboard 30 including at least the character input keys 22 corresponding to 26 alphabets, numbers and symbols that are different from one another, so that it is not necessary for a user to press the character input key more than once for inputting a target character like 12 character input keys in a conventional portable phone, thereby making it possible to input a character by touching once.

Note that, the virtual keyboard 30 is a QWERTY keyboard here, however, arrangement of the character input keys 22 is not limited thereto. In a case where arrangement different from the QWERTY arrangement is used as the arrangement of the character input keys 22, the adjacent character information 13a shown in FIG. 3 is modified appropriately according to arrangement to be used.

Returning to the description of FIG. 1, the finger trajectory information 13b is information on a trajectory of the finger 23 that has moved on the touch panel 12. Specifically, in the finger trajectory information 13b, a position of the touch panel 12 touched by a user and a coordinate value for a trajectory of the finger 23 that has moved thereafter are registered. The finger trajectory information 13b is registered by the touch panel 12.

The finger movement direction information 13c is information on the direction in which the finger 23 moves after a user touches the touch panel 12. The finger movement direction information 13c is information registered by a movement direction detection portion 14a described below.

The finger movement distance condition information 13d is information on predetermined conditions to be satisfied by the movement distance 31 of the finger 23 in the X-axis direction and the movement distance 32 of the finger 23 in the Y-axis direction that are shown in FIG. 4 so that the character input key 22 touched by the finger 23 is selected from among the character input key 22 touched by the finger 23 and the character input keys 22 placed adjacent to the touched character input key 22.

Specifically, a condition of Lx²/a²+Ly²/b²<1 is stored as the finger movement distance condition information 13c, where the movement distance 31 in the X-axis direction and the movement distance 32 in the Y-axis direction of the finger 23 in a case where a user touches a certain character input key 22, and thereafter moves the finger 23 without moving away from the touch panel 12 are Lx and Ly, respectively. In this case, a and b are positive constants. In a case where Lx and Ly satisfy the condition, a character registered as the “character without movement”, that is, a character of the character input key 22 touched first by a user is set as an input character in the adjacent character information 13a shown in FIG. 3.

FIG. 5 is a diagram explaining about the finger movement distance condition information 13d. FIG. 5 gives a case where a user touches a center part of the character input key 22 of “S”. The condition of Lx²/a²+Ly²/b²<1 corresponds to a condition where a position in which the finger 23 moves away from the touch panel 12 after a user moves the finger 23 is inside an ellipse 40. In such a case, the character “S” of the character input key 22 touched first by the user is set as the input character.

In this manner, a user sets the finger movement distance condition information 13d, thereby allowing the user to adjust a criterion which of the character input key 22 touched first by the user and the character input keys 22 placed adjacent to the touched character input key 22 is selected, so that operability of the character input device 10 is improved, while preventing erroneous input.

The direction definition information 13e is definition information on each movement direction to right, upper right, upper left, left, lower left or lower right in the adjacent character information 13a. For example, in a case where an angle of a position on a straight line horizontally extending on the right from a center point of the character input key 22 is set to 0° and the angle is increased in a counterclockwise direction, an area of −45°<θ≦45° as a right direction, an area of 45°<θ≦90° as an upper right direction, an area of 90°<θ≦135° as an upper left direction, an area of 135°<θ≦225° as a left direction, an area of 225°<θ≦270° as a lower left direction and an area of −90°<θ≦−45° as a lower right direction are defined.

The control portion 14 is a control portion that is comprised of a CPU (Central Processing Unit) and the like and entirely controls the character input device 10. The control portion 14 is provided with a movement direction detection portion 14a, an input character setting portion 14b and a display control portion 14c.

The movement direction detection portion 14a is a processing portion for detecting the movement direction of the finger 23 in a case where the finger 23 moves without moving away from the touch panel 12 after a user touches the touch panel 12 with the finger 23.

Specifically, the movement direction detection portion 14a detects movement distances Lx and Ly in the X-axis direction and the Y-axis direction of the finger 23. Further, the movement direction detection portion 14a calculates an angle θ by θ=arctan(−Ly/Lx). Note that, the range of arctan (−Ly/Lx) is set to −90°<θ<90° when the finger 23 moves in a positive direction of the X axis, and to 90°<θ<270° when the finger 23 moves in a negative direction of the X axis. Additionally, θ is set to 270° when the finger 23 moves in a positive direction of the Y axis where Lx=0, and θ is set to 90° when the finger 23 moves in a negative direction of the Y axis where Lx=0.

Then, the movement direction detection portion 14a determines that, for example, the movement direction is right in the case of −45°<θ≦45°, the movement direction is upper right in the case of 45°<θ≦90°, the movement direction is upper left in the case of 90°<θ≦135°, the movement direction is left in the case of 135°<θ≦225°, the movement direction is lower left in the case of 225°<θ≦270°, and the movement direction is lower right in the case of −90°<θ≦−45°.

Note that, the movement direction detection portion 14a detects here the movement direction of the finger 23 from the movement distances Lx and Ly in the X-axis direction and the Y-axis direction from a position touched by the finger 23, however, the direction corresponding to an area including the largest part of a trajectory of the finger 23 which moves without moving away from the touch panel 12 may be detected as the movement direction.

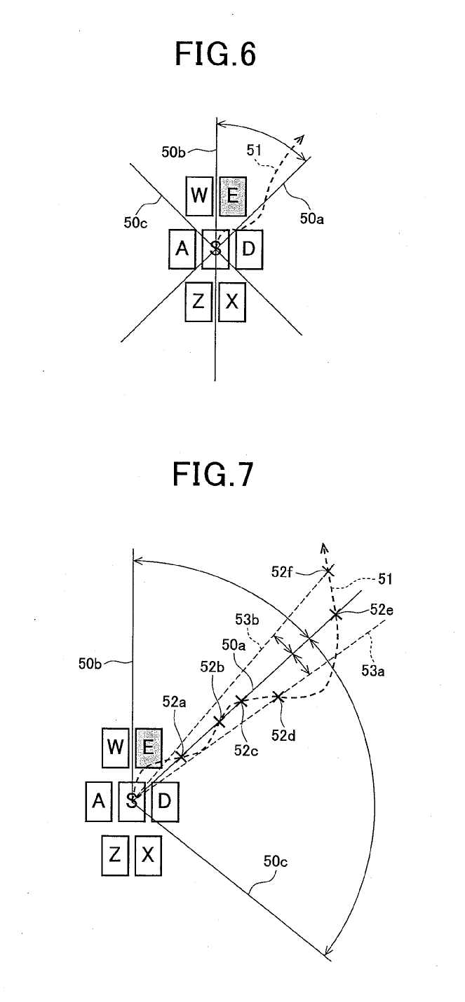

FIG. 6 is a diagram explaining about detection processing of the movement direction based on an area including a trajectory of the finger 23. As shown in FIG. 6, boundaries 50a to 50c are provided with respect to the character input keys 22, respectively, and an area on the touch panel 12 is divided into six areas corresponding to respective directions to right, upper right, upper left, left, lower left and lower right. Then, the movement direction detection portion 14a reads the finger trajectory information 13b stored in the storage portion 13 to obtain information on a trajectory 51 of the finger 23 which has moved without moving away from the touch panel 12. In an example of FIG. 6, although the trajectory 51 moves across the boundary 50a twice and a part of the trajectory 51 is included in an area corresponding to the character input key 22 of “D”, a larger part of the trajectory 51 is included in an area corresponding to the character input key 22 of “E”, and the movement direction detection portion 14a thus detects the upper right direction corresponding to the area of the character input key 22 of “E” as the movement direction of the finger 23.

In this manner, the direction corresponding to an area including the largest part of a trajectory of the finger 23 is detected as the movement direction, so that a user appropriately selects a target character even when the user moves the finger 23 near the boundaries 50a to 50c.

Moreover, when the finger 23 moves without moving away from the touch panel 12, the movement direction detection portion 14a may change a determination condition of the movement direction based on a movement history of the finger 23 that has moved in past times to detect the movement direction of the finger 23 based on the changed determination condition.

FIG. 7 is a diagram explaining about determination condition change processing of the movement direction. As described above, the boundaries 50a to 50c are provided with respect to respective character input keys 22 to divide an area on the touch panel 12 into areas corresponding to respective directions to right, upper right, upper left, left, lower left and lower right for detecting which area the finger 23 belongs to, thereby determining the movement direction of the finger 23. In an example of FIG. 7, when the finger 23 moves to the area of the character input key 22 of “E” which is sandwiched between the boundary 50a and the boundary 50b, the movement direction of the finger 23 is determined as the upper right.

However, when the finger 23 moves from a first area to a second area, the movement direction detection portion 14a rotates the boundaries 50a to 50c demarcating the first area and the second area to the second area side by only a predetermined angle. In an example of FIG. 7, when the finger 23 crosses over the boundary 50a at points 52a and 52c and moves from the area of the character input key 22 of “E” to the area of the character input key 22 of “D”, the movement direction detection portion 14a rotates the boundary 50a to the side of the area of the character input key 22 of “D” by only α° to modify the boundary 50a to the boundary 53a, thereby changing a determination condition of the movement direction to upper right.

In this case, when the finger 23 crosses over the boundary 50a at the points 52a and 52c, the movement direction detection portion 14a does not detect the movement direction of the finger 23 as the right direction corresponding to the character input key 22 of “D”, but detects as the upper right direction corresponding to the character input key 22 of “E”. When the finger 23 then crosses over the boundary 53a at a point 52d, the movement direction detection portion 14a detects the movement direction of the finger 23 as the right direction corresponding to the character input key 22 of “D”.

Similarly, when the finger 23 crosses over the boundary 50a at points 52b and 52e, and moves from the area of the character input key 22 of “D” to the area of the character input key 22 of “E”, the movement direction detection portion 14a rotates the boundary 50a to the side of the area of the character input key 22 of “E” by only α° to modify the boundary 50a to the boundary 53b, thereby changing the determination condition of the movement direction to right.

In this case, when the finger 23 crosses over the boundary 50a at the points 52b and 52e, the movement direction detection portion 14a does not detect the movement direction of the finger 23 as the upper right direction corresponding to the character input key 22 of “E”, but detects as the right direction corresponding to the character input key 22 of “D”. When the finger 23 then crosses over the boundary 53b at a point 52f, the movement direction detection portion 14a detects the movement direction of the finger 23 as the upper right direction corresponding to the character input key 22 of “E”.

In this manner, when the finger 23 moves without moving away from the touch panel 12, the determination condition of the movement direction is changed based on a movement history of the finger 23 that has moved in past times and hysteresis characteristics are introduced into determination of the movement direction, thereby allowing to reduce recognition errors of the touch panel 12 and limit the influence of wobbling of the finger 23 of a user even when the user moves the finger 23 near the boundaries 50a to 50c, so that the user appropriately selects a target character.

Returning to the description of FIG. 1, the input character setting portion 14b is a processing portion for setting, as an input character, one character specified by the position detected by the touch panel 12 and the movement direction detected by the movement direction detection portion 14a from among a character corresponding to the character input key 22 touched by the finger 23 and characters corresponding to the character input keys 22 placed adjacent to the touched character input key 22 based on the position detected by the touch panel 12, the movement direction detected by the movement direction detection portion 14a and the adjacent character information 13a stored in the storage portion 13.

For example, when a user touches the character input key 22 of “S” and thereafter moves the finger 23 to the upper right direction without moving away from the touch panel 12 on the virtual keyboard 30 shown in FIG. 4, the touch panel 12 detects that the character input key 22 of “S” is touched, while the movement direction detection portion 14a detects that the movement direction is the upper right. Accordingly, the input character setting portion 14b reads the adjacent character information 13a from the storage portion 13, and sets, as an input character, the character “E” on the upper right as the movement direction in a column of the “character corresponding to the movement direction of the finger” corresponding to “S” as the “character corresponding to the pressed key” from the adjacent character information 13a.

Note that, in a case where the movement distances Lx and Ly in the X-axis direction and the Y-axis direction of the finger 23 when a user touches a certain character input key 22 and thereafter moves the finger 23 without moving away from the touch panel 12 satisfy the condition of Lx²/a²+Ly²/b²<1 that is set as the finger movement distance condition information 13d, the input character setting portion 14b sets the character “S” of the character input key 22 touched by the user as an input character.

Returning to the description of FIG. 1, the display control portion 14c is a processing portion for controlling the display portion 11 to display information. For example, the display control portion 14c transmits a control signal to the display portion 11 to cause the display portion 11 to display the character input screen 20 as shown in FIG. 2(b). Further, the display control portion 14c transmits a control signal to the display portion 11 and causes the display portion 11, when one of the character input keys 22 on the virtual keyboard 30 is touched by a user, to display key layout information including the touched character input key 22 and the character input keys 22 placed adjacent to the touched character input key 22 in a position, separately from the virtual keyboard 30, that is not overlapped with the virtual keyboard 30.

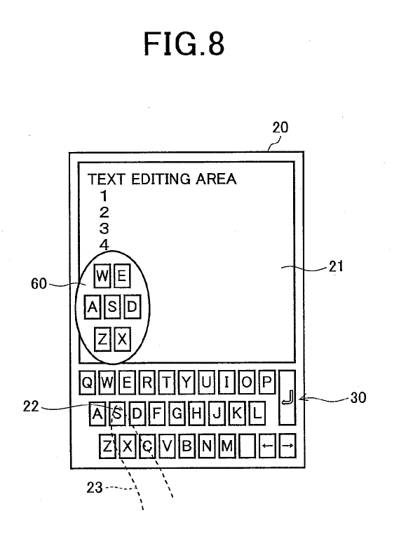

FIG. 8 is a diagram showing an example of key layout information 60. As shown in FIG. 8, when the character input key 22 of “S” on the virtual keyboard 30 is touched by a user with the finger 23, the display control portion 14c causes the display portion 11 to display the key layout information 60 including the character input key 22 of “S” and the character input keys 22 of “D”, “E”, “W”, “A”, “Z” and “X” placed in positions adjacent to the character input key 22 of “S” in a position that is not overlapped with the virtual keyboard 30.

In this manner, in a case where the display portion 11 displays the key layout information 60 in an area separately from the virtual keyboard 30, since the character input key 22 in the touched position and the character input keys 22 placed adjacent to the touched character input key 22 are not hidden with the finger 23, it is possible for a user to easily confirm those character input keys 22 and to select a target character input key 22 quickly.

Additionally, when one of the character input keys 22 on the virtual keyboard 30 is touched by a user and the finger 23 thereafter moves without moving away from the touch panel 12, the movement direction detection portion 14a detects the movement direction of the finger 23, and the input character setting portion 14b selects a character corresponding to the movement direction as a candidate for an input character. In this case, the display control portion 14c transmits a control signal to the display portion 11, and causes the display portion 11 to highlight the character input key 22 being selected at the time by making a display color of the character input key 22 being selected at the time different from a display color of the other character input keys 22, or the like.

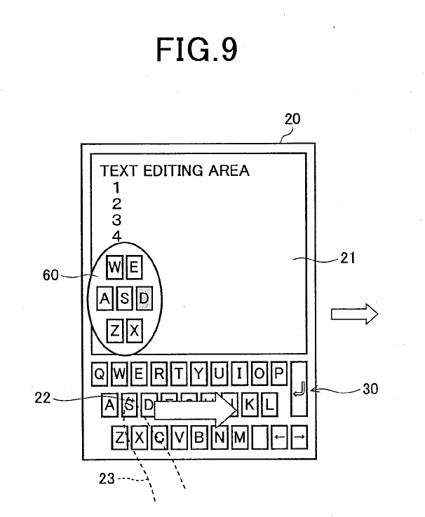

FIG. 9 is a diagram showing an example of highlighting processing of the character input key 22. As shown in FIG. 9, in a case where the character input key 22 of “S” on the virtual keyboard 30 is touched with the finger 23 by a user and the finger 23 thereafter moves to the right without moving away from the touch panel 12 to select the character input key 22 of “D”, the display control portion 14c transmits a control signal to the display portion 11, and causes the display portion 11 to highlight the character input key 22 of “D” by making a display color of the character input key 22 of “D” different from a display color of the other character input keys 22.

In this manner, the display portion 11 highlights the character input key 22 being selected at the time, so that a user easily confirms which character input key 22 is being selected at the time to select a target character input key 22 quickly.

When the finger 23 of the user moves away from the touch panel 12 thereafter, a character corresponding to the character input key 22 touched first by the user or the character input keys 22 placed adjacent to the touched character input key 22 is set as an input character by the input character setting portion 14b.

As clarified from the description so far, the above-described input character is not a character that is displayed in a position from which the finger 23 moves away when the finger 23 of a user moves away from the touch panel 12 but a character selected always based on the above-described method at the time. For example, as shown in FIGS. 8 and 9, even in a case where a user first touches the character input key 22 of “S” with finger 23, and the finger 23 thereafter moves to the right without moving away from the touch panel 12 to pass the character input key of “D”, then the finger 23 moves away from the touch panel 12 in a position of the character input key of “F”, “F” is not set as an input character, but “D” is set as an input character based on the adjacent character information 13a and information on the movement direction.

Then, as described above, in a case where the finger 23 of the user moves away from the touch panel 12, and a character corresponding to the character input key 22 that is touched first by the user or the character input keys 22 placed adjacent to the touched character input key 22 is set as an input character by the input character setting portion 14b, the display control portion 14c transmits a control signal to the display portion 11 and causes the display portion 11 to execute pop-up display of the character which is set as the input character.

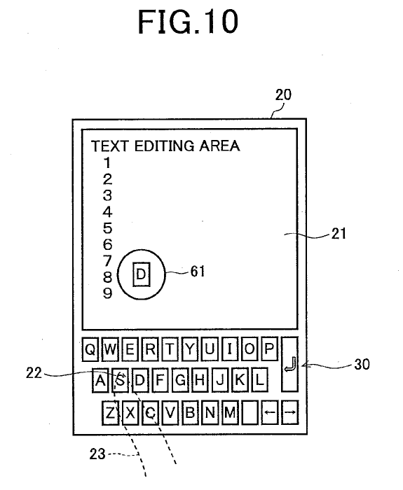

FIG. 10 is a diagram showing an example of pop-up display processing of a character. In an example of FIG. 10, when the character input key 22 of “S” is touched by a user and the finger 23 thereafter moves without moving away from the touch panel 12 to select the character input key 22 of “D”, then the finger 23 of the user moves away from the touch panel 12, the display control portion 14c transmits a control signal to the display portion 11, and causes the display portion 11 to execute pop-up display 61 of the character “D” corresponding to the selected character input key 22.

In this manner, the display portion 11 executes pop-up display of a character which is set as an input character, so that a user easily confirms whether or not a target character is set as the input character and to input subsequent characters at ease.

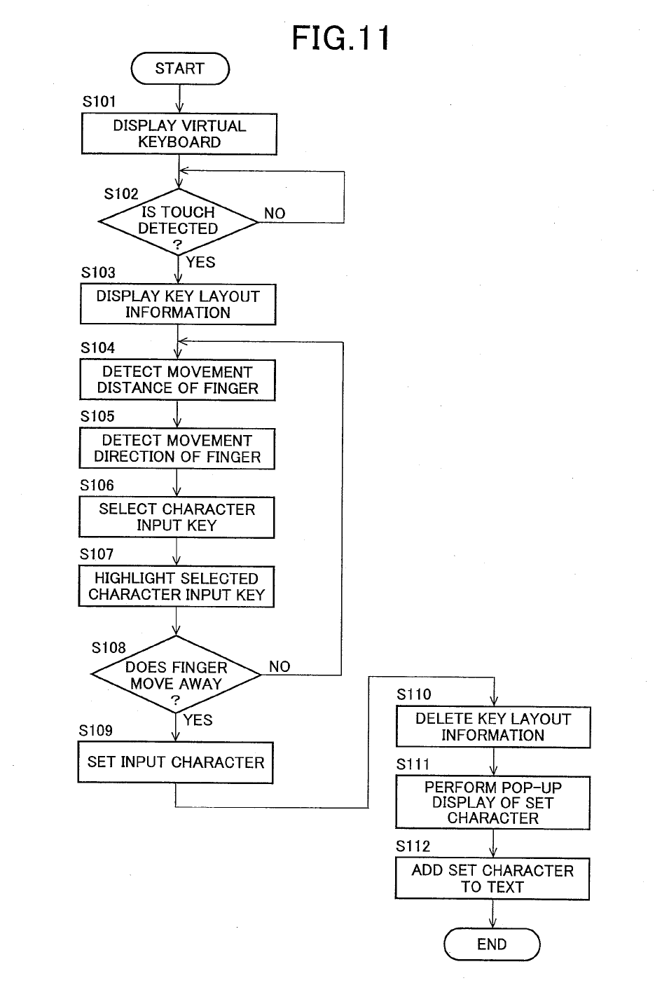

Next, description will be given for an example of a processing procedure of a character input method according to the present embodiment. FIG. 11 is a flowchart showing an example of the processing procedure of the character input method according to the present embodiment. As shown in FIG. 11, first, the display portion 11 of the character input device 10 displays the virtual keyboard 30 (step S101). The touch panel 12 then detects whether or not the character input key 22 on the virtual keyboard 30 is touched by a user (step S102).

In a case where the character input key 22 is not touched (in the case of NO at step S102), the process moves to step S102, and the touch panel 12 continuously detects whether or not the character input key 22 on the virtual keyboard 30 is touched by the user. In a case where the character input key 22 is touched (in the case of YES at step S102), the display portion 11 displays the key layout information 60 for the touched character input key 22 like an example shown in FIG. 8 (step S103).

Thereafter, the movement direction detection portion 14a detects the movement distances Lx and Ly in the X-axis direction and the Y-axis direction from the position touched by the finger 23 (step S104). The movement direction detection portion 14a then detects the movement direction of the finger 23 from the movement distances Lx and Ly (step S105). Here, the movement direction of the finger 23 may be detected by calculating an angle θ=arctan(−Ly/Lx) as described above, detected based on an area including the largest part of a trajectory of the finger 23 which has moved, or detected based on the movement history of the finger 23 that has moved in past times.

Subsequently, the input character setting portion 14b uses the character input key 22 which is touched first, the detected movement direction as well as the adjacent character information 13a stored in the storage portion 13 to select the character input key 22 which is touched first as well as one character input key 22 specified by the detected movement direction from among the character input key 22 which is touched first as well as the character input keys 22 placed adjacent to the touched character input key 22 (step S106).

The display portion 11 then highlights the selected character input key 22 in a display color different from that of other character input keys 22 included in the key layout information 60 like an example shown in FIG. 9 (step S107). Thereafter the input character setting portion 14b determines whether or not the finger 23 of the user moves away from the touch panel 12 (step S108). In a case where the finger 23 of the user does not move away from the touch panel 12 (in the case of NO at step S108), the process moves to step S104, detection processing of the movement distances Lx and Ly in the X-axis direction and the Y-axis direction from the position touched by the finger 23 is executed again, and subsequent processing is continuously executed.

In a case where the finger 23 of the user moves away from the touch panel 12 (in the case of YES at step S108), the input character setting portion 14b sets a character corresponding to the character input key 22 selected at step S106 as an input character input by the user (step S109). The display portion 11 then deletes the key layout information 60 (step S110).

Subsequently, the display portion 11 executes pop-up display of the character which is set as the input character at step S109 like an example shown in FIG. 10 (step S111). The input character setting portion 14b then adds the character which is set as the input character to a text being edited (step S112), and finishes the character input processing.

Description has so far been given mainly for the embodiments of the character input device and the character input method, however, the present invention is not limited to these embodiments, and the present invention may be implemented as a form of a computer program for realizing functions of the character input device, or a form of a computer-readable recording medium having the computer program recorded thereon.

In the invention, various forms of recording media are allowed to be employed including disc types (for example, a magnetic disc, an optical disc and the like), card types (for example, a memory card, an optical card and the like), semiconductor memory types (for example, a ROM, a non-volatile memory and the like), tape types (for example, a magnetic tape, a cassette tape and the like), and the like.

Computer programs that realize the functions of the character input device in the above-described embodiments or computer programs that cause a computer to execute the character input method are recorded on these recording media to be distributed, thereby making it possible to reduce cost and to improve portability and versatility.

Additionally, a computer is equipped with the above-described recording medium, then a computer program that is recorded in the recording medium is read by the computer to be stored in a memory, and a processer provided in the computer (CPU: Central Processing Unit, MPU: Micro Processing Unit) reads the computer program from the memory for execution, so that it is possible to realize the functions of the character input device according to the present embodiments and execute the character input method.

Further, the present invention is not limited to the above-described embodiments, and various changes and modifications are able to be made without departing from the spirit of the present invention.

### EXPLANATIONS OF LETTERS OR NUMERALS

10 . . . character input device; 11 . . . display portion; 12 . . . touch panel; 13 . . . storage portion; 13a . . . adjacent character information; 13b . . . finger trajectory information; 13c . . . finger movement direction information; 13d . . . finger movement distance condition information; 13e . . . direction definition information; 14 . . . control portion; 14a . . . movement direction detection portion; 14b . . . input character setting portion; 14c . . . display control portion; 20 . . . character input screen; 21 . . . text display area; 22 . . . character input key; 23 . . . finger; 30 . . . virtual keyboard, 31 . . . movement distance of a finger in an X-axis direction; 32 . . . movement distance of a finger in a Y-axis direction; 40 . . . ellipse; 50a to 50c, 53a, 53b . . . boundary; 51 . . . trajectory of a finger; 52a to 52f . . . point; 60 . . . key layout information; and 61 . . . pop-up display.

1. A character input device for executing character input processing, comprising:
a display portion for displaying a virtual keyboard including a plurality of character input keys corresponding to respective characters;
a touch panel for detecting a position touched by a finger on the virtual keyboard displayed by the display portion;
a movement direction detection portion for detecting a movement direction in which the finger moves without moving away from the touch panel after the touch panel is touched;
a storage portion for storing adjacent character information in which information on characters of adjacent character input keys that are adjacent to the touched character input keys is registered, in association with information on the movement direction of the finger in which the finger moves without moving away from the touch panel after the character input key is touched; and
an input character setting portion for extracting one character from among the character corresponding to the character input key that is touched by the finger and characters corresponding to the adjacent character input keys placed adjacent to the touched character input key based on the position of the touch panel touched by the finger, the movement direction detected by the movement direction detection portion, and the adjacent character information stored in the storage portion to set the extracted character as an input character.

2. The character input device as defined in claim 1, wherein
the adjacent character information stored in the storage portion is set based on key arrangement of the virtual keyboard which is displayed before the touch is performed on the touch panel by the finger.

3. The character input device as defined in claim 1, wherein
the movement direction detection portion detects a first movement distance of a finger on a first coordinate axis and a second movement distance of the finger on a second coordinate axis perpendicular to the first coordinate axis on an orthogonal coordinate system, the storage portion stores predetermined conditions to be satisfied by the first movement distance and the second movement distance so that the character input key touched by the finger is selected from among the character input key that is touched by the finger or the adjacent character input keys placed adjacent to the touched character input key, and the input character setting portion sets a character corresponding to the character input key that is touched by the finger as the input character in a case where the first movement distance and the second movement distance satisfy the predetermined conditions.

4. The character input device as defined in claim 3, wherein
the movement direction detection portion detects the movement direction of the finger based on the first movement distance and the second movement distance.

5. The character input device as defined in claim 1, wherein
the movement direction detection portion detects a direction corresponding to an area including the largest part of a trajectory of the finger which has moved without moving away from the touch panel as the movement direction.

6. The character input device as defined in claim 1, wherein
the display portion displays the virtual keyboard and, when one of the plurality of character input keys is touched, displays key layout information including the touched character input key and adjacent character input keys placed adjacent to the touched character input key in an area different from a display area of the virtual keyboard.

7. The character input device as defined in claim 6, wherein
the input character setting portion selects, when a finger moves without moving away from the touch panel, one character from among the character corresponding to the character input key that is touched by the finger and the characters corresponding to the adjacent character input keys placed adjacent to the touched character input key based on the position of the touch panel touched by the finger, the movement direction detected by the movement direction detection portion and the adjacent character information stored in the storage portion, and the display portion displays the key layout information in which the character selected by the input character setting portion is highlighted.

8. The character input device as defined in claim 1, wherein
the display portion performs pop-up display of the character which is set as the input character by the input character setting portion when a finger moves away from the touch panel.

9. The character input device as defined in claim 1, wherein
the virtual keyboard includes at least character input keys corresponding to 26 alphabets, numbers and symbols that are different from one another.

10. The character input device as defined in claim 1, wherein
the movement direction detection portion changes a determination condition of a movement direction based on a movement history of a finger that has moved in past times and detect the movement direction based on the changed determination condition when the finger moves without moving away from the touch panel.

11. A character input method of executing character input processing, comprising:
a displaying step of displaying a virtual keyboard including a plurality of character input keys corresponding to respective characters;
a position detecting step of detecting a position of a touch panel touched by a finger;
a movement direction detecting step of detecting a movement direction in which the finger moves without moving away from the touch panel after the touch panel is touched;
a reading step of reading, from the storage portion, adjacent character information in which information on characters of adjacent character input keys that are placed adjacent to the touched character input key is registered, in association with information on the movement direction of the finger in which the finger moves without moving away from the touch panel after the character input key is touched; and
an input character setting step of extracting one character from among the character corresponding to the character input key that is touched by the finger and the characters corresponding to the adjacent character input keys placed adjacent to the touched character input key based on the position of the touch panel touched by the finger detected at the position detection step, the movement direction detected at the movement direction detection step, and the adjacent character information read out at the reading step to set the extracted character as an input character.
